(19) United States
(12) Patent Application Publication
(10) Pub. No.: US 2010/0062121 A1
(43) Pub. Date: Mar. 11, 2010

(54) Microwave Hydrodiffusion for Isolation of Natural Products

(75) Inventors: Chemat Farid, Avignon Cedex (FR); Maryline Vian, Avignon Cedex (FR); Francesco Visinoni, Sorisole (BG) (IT)

Correspondence Address: MARSHALL, GERSTEIN & BORUN LLP, 233 SOUTH WACKER DRIVE, 6300 SEARS TOWER, CHICAGO, IL, 60606-6357, US

(73) Assignees: MILESTONE S.r.l., Soriole (BG) (IT); UNIVERSITE D'AVIGNON ET DES PAYS DE VAUCLUES, Avignon Cedex 1 (FR)

(21) Appl. No.: 12/523,680

(22) PCT Filed: Jan. 21, 2008
(86) PCT No.: PCT/EP2008/000431

§ 371 Date: Aug. 19, 2009

(30) Foreign Application Priority Data
Jan. 22, 2007 (EP) 07100935.1

(51) Int. Cl. B01D 17/06; A23L 3/01; A23L 3/015

(52) U.S. Cl. 426/241; 210/634; 210/748.07

(57) ABSTRACT

The present invention relates to the isolation of biological materials by hydrodiffusion by microwave irradiation, to an apparatus suitable for carrying out present method and to a system for carrying out the present method continuously.

### FIELD OF THE INVENTION

The present invention relates to a process for the isolation of natural products by microwaves. More specifically, the process uses microwaves for hydrodiffusion of biochemical compounds from biological material to the exterior of such biological material and earth gravity to collect and separate them. The invention also relates to an apparatus for carrying out said method and to a system for carrying out said method continuously.

### BACKGROUND OF THE INVENTION

The isolation methods known in the art for isolating natural products are generally based on distillation, i.e. the in situ vaporization of the desired compound, and/or the use of organic solvents.

Recently, new methods based on the use of microwaves for extraction of natural products have been developed. For instance, a microwave assisted process (map) achieves the isolation of extracts or concretes by solvent extraction under microwave irradiation. The MAP extraction process, described for instance in EP 0398798 and in U.S. Pat. No. 5,002,784, consists in immersing the raw material to be extracted in a solvent, the solvent being selected for its ability to dissolve the sought compounds and for its transparency to microwaves. Upon microwave irradiation, the temperature difference between the solvent and the target compound forces the compound into the solvent. The resulting solution is then separated from the raw material and processing eventually leads to the removal of the target compound.

Another process for microwave extraction of natural products is described for instance in U.S. Pat. No. 7,001,629 B1. This process is referred to in the art as vacuum microwave hydrodistillation (vmhd). The process essentially consists in isolating essential oils from biological products by subjecting said biological product to microwaves under vacuum. The combined effect of selective heating by microwaves and the vacuum pressure in the extraction chamber causes the essential oil to vaporize with the biological water present in the biological material being extracted. The vapor is then condensed and collected. A limitation of this process is that it only allows isolation of compounds which are distillable, in particular essential oils.

The above-mentioned processes thus present limitations in terms of solvent choice, ease of method, and also in terms of the extracts obtainable by these methods.

### OBJECT OF THE INVENTION

In view of the above, there thus still remains a need to provide an improved process for the isolation of natural products which overcomes at least some of the limitations of the known methods.

### SUMMARY OF THE INVENTION

Accordingly, this is achieved by the features of the independent claims. The dependent claims further develop the central idea of the invention.

Thus, in a first aspect, the present invention relates to a method for isolating natural products from biological material comprising the steps of:
a. Subjecting the biological material to microwave irradiation in a microwave oven (3),
b. Allowing the isolates from said biological material to drop by gravity out of the microwave oven (3) through a condenser (5) connected to a receiving flask (8),
c. Collecting directly the isolate in the receiving flask (8).

In a second aspect, the present invention pertains to an apparatus for isolating natural products from biological material comprising a microwave oven (3) comprising a flask (1) for containing the biological material, said flask (1) having a filter (2) and at least one opening facing downwards (9) such that the filter is above said opening, the microwave oven being such that an opening (4) on its lower side allows the opening of the flask (9) to extend from inside the oven to outside, the flask (1) being connected to a condenser (5), which is connected to a receiving flask (8) for collecting said natural products from the biological material.

Finally, the invention provides an apparatus for the continuous isolation of natural products from biological material by microwave irradiation comprising

a feed-through (18) comprising an active transport mechanism (11) for transporting the biological material through a microwave oven (3), and a cooling system (5) connected to a receiving flask (8) which are placed under the microwave oven (3), said feed-through having a main body (16) having a lower surface (17) which, in the microwave oven (3), is permeable to the isolates of said biological material, in order to allow the isolated to drop out of the microwave oven in the receiving flask (8).

### FIGURES

The present invention is further described hereinafter with reference to some of its embodiments shown in the accompanying figures in which:

FIGS. 1a, 1b and 1c depict embodiments of an isolation apparatus according to the present invention, and

FIG. 2 depicts a system for the continuous isolation of natural products according to the present invention.

### DETAILED DESCRIPTION OF THE INVENTION

In the following, the term “biological material” is intended to cover any natural source such as plants, spices, food products, seeds etc.

The term “natural product” is intended to cover any biochemical material which is obtainable from said biological material. The isolates referred to in the present description are thus natural products.

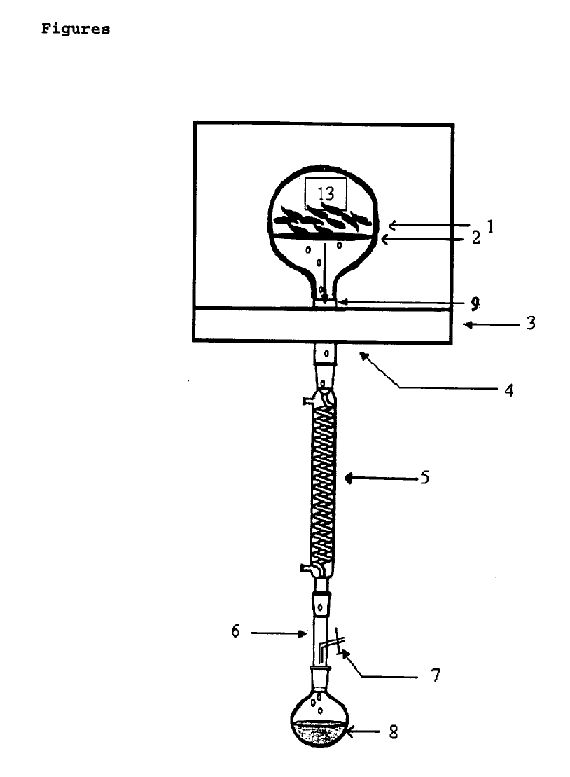

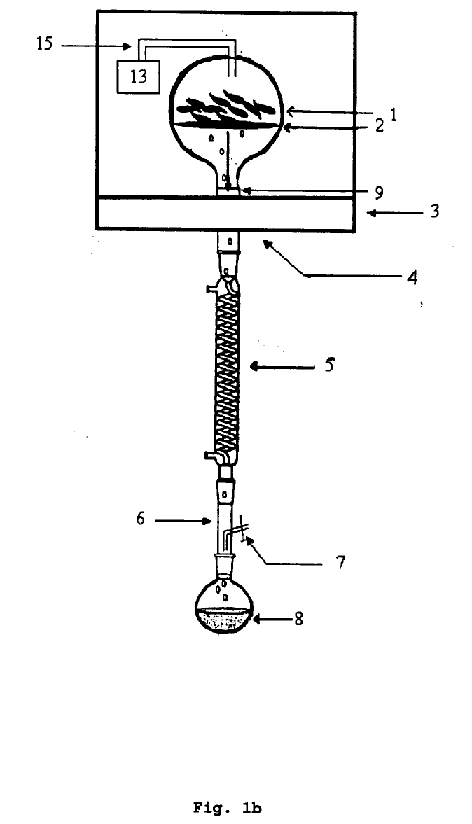

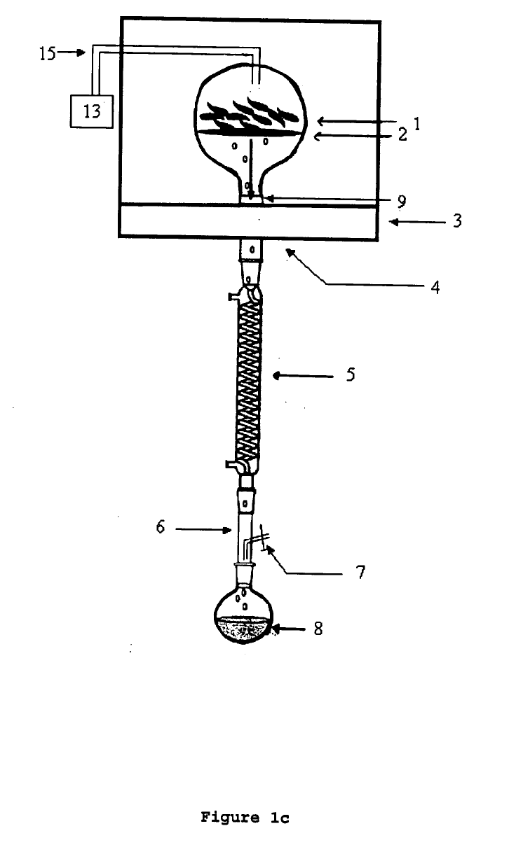

Referring to FIG. 1a, an installation for the isolation of natural products from a biological material is shown schematically. Such apparatus comprises a microwave oven (3) comprising a flask (1) for containing the biological material.

The microwave oven (3) may be any microwave used commonly in the art. For instance, it may be a Milestone ETHOS microwave oven. Preferably, it is a multi mode microwave reactor having a twin magnetron (2×800 W, 2455 MHz) with a maximum delivered power of 1000 W variable in 10 W increments.

The flask (1) for containing the biological material may be any flask suited for microwave reactions. Preferably, the flask is a traditional glass round-bottom flask. The flask (1) is provided with a filter (2) and at least one opening facing downwards (9) such that the filter is above said opening.

The filter is chosen such that it is permeable to the isolates of the biological material. Typically, the filter is in the form of a perforated disc. Preferably, it is a micropore filter.

The microwave oven is such that it contains an opening (4) on its lower side such that it allows the opening of the flask (9) to extend from inside the oven to outside. Thus, the flask (1) may extend outside the microwave oven and may be connected to a receiving flask (8) for collecting the isolates of the biological material. The receiving flask may be any recipient used in the art. It may also be a separating funnel. This is advantageously used when the isolates collected are water insoluble and thus easily separable. Such isolates are, for example, essential oils.

In the embodiment shown in FIG. 1a, a cooling system (5) may be placed in between flask (1) and the receiving flask (8). The cooling system may be any system used in the art, for example a water or air condenser. The apparatus shown in FIG. 1a further comprises a connector (6) placed above the receiving flask (8). The connector is provided with a side opening comprising a valve (7).

When the valve is open, the whole apparatus is under atmospheric pressure. Alternatively, the valve may be open and the opening may be connected to a vacuum pump. This allows to set the apparatus under vacuum pressure. This is of particular interest when the compound to be isolated is sensitive to high temperatures which may be caused by microwave irradiation.

The biological material according to the invention may be dry or may contain some moisture. If the material is dry, steam is preferably brought in contact with the material. The steam may be produced by an in situ steam generator, or by an external steam generator. Preferably, the steam is produced by an in situ steam generator which may be selected from cotton, water etc.

FIG. 1a shows an embodiment of an apparatus according to the present invention wherein a steam generator (13) is placed in the flask (1) containing the biological material. Thus, the steam generated is in immediate contact with the biological material, thus facilitating the hydrodiffusion of compounds contained in the biological material.

According to another embodiment shown in FIG. 1b, the steam generator (13) may be placed outside the flask (1) and connected to the flask via a connecting tube (15). The steam generator (13) may be placed in the microwave cavity (3) as shown in FIG. 1b or may be placed externally from the cavity as shown in FIG. 1c. When placed externally, the steam generator may be an external electric steam generator.

According to a preferred embodiment, the in situ steam generator may be selected from cotton or water. When cotton is used as the in situ steam generator, the cotton is preferably wrapped in a compress. Under the effects of microwaves, the cotton material releases steam which aids the extraction of dried biological materials. Alternatively, water may be placed in a flask, such that upon microwave irradiation, steam is generated and brought in contact with the biological material.

Using the apparatus of the invention, a method for isolating natural products from biological materials may be carried out. Such method is part of the invention and is described in the following.

According to the present invention, the method for isolating natural products from biological material comprises the steps of subjecting the biological material to microwave irradiation in a microwave oven and allowing isolates of said biological material to drop by gravity out of the microwave oven. The isolates obtainable by said method are thus natural products of said biological material. Preferably, the isolation method is carried out by hydrodiffusion.

As shown in FIG. 1a, the biological material is therefore placed in a flask (1), preferably on a filter (2). The filter is typically a micropore filter which is permeable to the crude isolates.

In the present invention, the biological material may be selected from plants, spices, food products, seeds etc. It may be dry or may contain moisture.

The flask (1) containing the biological material is then subjected to microwave irradiation. The direct interaction of microwaves with biological water (i.e. steam produced from the water present in the fresh biological material) or with generated steam favours the release of compounds trapped inside the cells of the biological material, such as plant tissues, for example. These compounds thus move naturally by diffusion out of the cells of the biological material and, under the effect of earth gravity tend to move downwards, through the filter (2), and into a receiving flask (8).

Without being bound by theory, the principle of the present invention is based on the diffusion of biochemical compounds from the cells of the biological material (e.g. plants) to the outside. Gravity is then used to collect the isolates. In this way, compounds isolated by the method of the invention are richer, denser, of a superior aromatic bounty. They may also be enriched by non-distillable compounds such as heavy molecules like colorants, antioxidants (polyphenols, carotenoids), antimicrobials etc. The invention thus provides a great advantage over extraction methods of the art, whereby only distillable compounds are obtainable.

According to an embodiment of the present method, the crude natural product which has diffused out of the biological material, may also contain steam resulting from the biological water present in the biological material. The crude natural products and steam thus pass through the filter and fall down by gravity through a condenser (5) which is connected to a receiving flask (8). The presence of the condenser (5) accelerates the collection step of the present invention. The crude isolates obtained in the receiving flask (8) may then be further processed.

In the case of natural products which are miscible in water such as, for example, antioxidants, phytochemicals, colorants etc., the condensate may be further treated by extraction techniques known in the art. These include liquid-liquid extraction, solid-phase extraction or other extraction techniques known in the field. This processing presents the advantage that the natural products are further purified and/or enriched.

In the case of natural products which are poorly water-soluble, such as essential oils for example, the receiving flask (8) is preferably a separating funnel. In this way, the oily condensate is collected continuously and the essential oil can then be easily separated from the water.

The present invention offers a wide usability. Indeed, the biological materials which can be processed may be selected from plants, spices, food products, seeds etc. They may be dry or may contain moisture.

The natural products obtained may also vary and belong to a wide range of different compounds such as antioxidants, phytochemicals, colorants, essential oils, antimicrobials, vitamins etc.

The process of the present invention can be performed at atmospheric pressure, reduced pressure or even under pressure. Furthermore, the pressure may be kept constant throughout the isolation process or may be varied. Typically, the temperature of isolation is between 40° C. and 200° C., preferably between 50° C. and 100° C. Performing the method of the invention under vacuum pressure allows the hydrodiffusion to occur at lower temperature, and is thus particularly useful in isolating thermolabile products. Accordingly, the present method offers a wide scope of applications.

During the method of the invention, time, temperature, pressure and power can be monitored or controlled. This is typically achieved with an “easy wave” software package, for example. The temperature can also be monitored during the method of the invention with the aid of a shielded thermocouple (ATC-300) which may be inserted directly into a flask (1).

The present invention further presents the advantage that no organic solvent or water is needed to perform the isolation. Furthermore, the present method provides a rapid, efficient, energy saving, and an environmental friendly way in which compounds of use for food, pharmaceuticals, cosmetic industries etc. can be obtained.

According to a further embodiment of the present invention, a system for the continuous isolation of natural product from biological material by microwave irradiation is also provided.

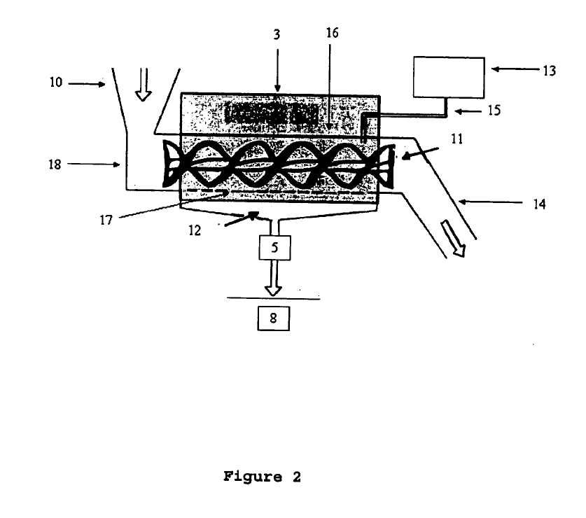

Referring to FIG. 2, the system comprises a feed-through (18) for transporting the biological material through a microwave oven (3). The feed-through typically has a main body (16) having a lower surface (17) which, in the microwave oven (3), is permeable to the isolates of said biological material. Preferably, the lower surface (17) is permeable on a macroscopic scale, such that all types of crude isolates can be further collected.

Preferably, the feed-through of the system of the invention comprises a feeder (10) for introducing the biological material, a main body (16) which is at least partially placed inside the microwave oven, and an outlet (14) for disposing of the biological material after passage through the microwave oven.

Preferably, the feed-through (18) comprises an active transport mechanism (11) which can be selected from an automated endless screw, a conveyer belt, etc.

In the case of isolation from dried products, a steam generator (13) may be placed inside the main body of the feed-through (18) or may be placed externally and connected to the inside of the feed-through via a connecting tube (15).

The system may also be provided with a funnel (12) placed under the microwave oven in order to collect the crude isolates which, under gravity, fall through the permeable membrane of the feed-through. A receiving flask (8) may then be connected to the funnel (12). Preferably, a cooling system (5) such as a condenser, is placed above the receiving flask.

The system may be used under atmospheric pressure, under vacuum or under pressure. The system is particularly useful in that it allows the continuous isolation of natural products from biological materials, and is particularly suitable for obtaining essential oils.

A typical processing method using the system of the invention includes the step of feeding the biological material into the system via a feeder (10). The biological material is then transported through the microwave oven (3) where it undergoes microwave irradiation. The crude isolates which are obtained by hydrodiffusion are then allowed to seep through the permeable membrane (17) by gravity and be collected into a receiving flask (8). The transport mechanism (11) allows the biological material to travel through the microwave oven and upon exiting the microwave oven, the processed biological materials can be disposed of via an outlet (14).

It is also conceivable that the outlet (14) may be reconnected to the feeder such that a second cycle using the same biological material may be carried out.

This continuous system provides an efficient way to obtain compounds by hydrodiffusion. As described above, the compounds obtained by the present invention may be used in a wide range of application.

The present invention is further illustrated hereinafter with the following examples which are not to be considered as limiting the scope of the invention.

### EXAMPLES

### Example 1

### Isolation of Essential Oils from Fresh Plants Using Microwave Hydrodiffusion

Orange peels were placed in an apparatus according to the invention and subjected to microwave irradiation. After an extraction time of 5-10 minutes, the yield of essential oils obtained with the present microwave hydrodiffusion method at atmospheric or reduced pressure was equal to that obtained by conventional distillation methods after 180 minutes.

One of the greatest advantages of the present microwave hydrodiffusion method is its rapidity.

### Example 2

### Isolation of Essential Oils from Dry Plants Using Microwave Hydrodiffusion

Dry lavender flowers were placed in an apparatus according to the invention and subjected to microwave irradiation. Steam was provided by an in situ or by an external steam generator during extraction. The yield of essential oils obtained with the present microwave hydrodiffusion method was comparable to that obtained by conventional distillation methods. The time of extraction was between 5 and 10 minutes.

### Example 3

### Isolation of Phytochemicals from Grape Berries Using Microwave Hydrodiffusion

Grape berries were placed in the apparatus of the present invention and subjected to microwave irradiation. The crude juice was collected into a receiving flask in only 10 minutes. The present process favours the release of compounds trapped inside the cells as polyphenols.

In this way, the invention provides a method which enables a high increase in the extraction of phenolic components and tannins in very short time.

### Example 4

### Isolation of Phytochemicals from Tomatoes Using Microwave Hydrodiffusion

Tomatoes were placed in an apparatus according to the invention and subjected to microwave irradiation. Phytochemical crude isolates (150 mL) were collected into a receiving flask in only 10 minutes. The phytochemical crude extract could be treated either by liquid-liquid extraction, solid-phase extraction etc. for analysis or enrichment purposes.

### Example 5

### Continuous Isolation of Essential Oils

Oranges and/or lavender were fed into a system according to the present invention at a rate varying from between 10 to 1000 Kg per hour. The yield of essential oil obtained from orange peels and/or lavender ranged between 0.1 to 5%. The present invention provided a substantial saving of time and energy.

1. Method for isolating natural products from biological material comprising the steps of:
(a) subjecting biological material to microwave irradiation in a microwave oven,
(b) allowing isolates from said biological material to drop by gravity out of the microwave oven through a condenser connected to a receiving flask, and
(c) directly collecting the isolates in the receiving flask.

2. Method according to claim 1, comprising further processing the isolates.

3. Method according to claim 1, wherein the biological material is selected from the group consisting of plants, spices, food products, and seeds.

4. Method according to claim 1, wherein the natural products are selected from the group consisting of antioxidants, phytochemicals, colorants, essential oils, antimicrobials, and vitamins.

5. Method according to claim 1, comprising carrying out said method at atmospheric pressure.

6. Method according to claim 1, comprising varying the pressure during the isolation.

7. Method according to claim 1, wherein the temperature of isolation is between 40° C. and 200° C.

8. Method according to claim 1, wherein the biological material is dry.

9. Method according to claim 8, comprising bringing steam in contact with the dry biological material.

10. Method according to claim 9, comprising producing the steam by an in situ steam generator.

11. Method according to claim 10, comprising generating the steam from cotton or water.

12. Method according to claim 1, comprising completely isolating said natural products from said biological material.

13. Apparatus for isolating natural products from biological material comprising a microwave oven comprising a flask for containing biological material, said flask having a filter and at least one opening facing downwardly such that the filter is above said opening, the microwave oven having an opening on a lower side of the microwave oven that allows the opening of the flask to extend from inside the oven to outside the oven, the flask being connected to a condenser, which condenser is connected to a receiving flask for collecting said natural products from the biological material.

14. Apparatus according to claim 13, said apparatus comprising a connector placed between the condenser and the receiving flask, said connector being provided with a side opening comprising a valve.

15. Apparatus according to claim 14, wherein the side opening valve of the connector is open to atmospheric pressure.

16. Apparatus according to claim 14, wherein the side opening valve of the connector is connected to a vacuum pump.

17. Apparatus according to claim 13, wherein the flask comprises an in situ steam generator.

18. Apparatus according to claim 13, wherein the microwave oven comprises an in situ steam generator connected to the flask via a connecting tube.

19. Apparatus according to claim 13, wherein an external steam generator is connected to the flask via a connecting tube.

20. Apparatus according to claim 17, wherein the steam generator generates steam from cotton or water.

21. Apparatus for the continuous isolation of natural products from biological material by microwave irradiation comprising
a feed-through comprising an active transport mechanism for transporting biological material through a microwave oven, and a cooling system connected to a receiving flask, the cooling system and flask being placed under the microwave oven, said feed-through having a main body having a lower surface that, in the microwave oven, is permeable to isolates of said biological material to allow the isolates to drop out of the microwave oven into the receiving flask.

22. Apparatus according to claim 21, wherein the lower surface of the feed-through in the microwave oven is permeable to said isolates on a macroscopic scale.

23. Apparatus according to claim 21, wherein the feed-through comprises a feeder for introducing the biological material, a main body at least partially placed inside the microwave oven, and an outlet for disposing of the biological material after passage through the microwave oven.

24. Apparatus according to claim 21, wherein the active transport mechanism is an automated endless screw or a conveyor belt.

25. Apparatus according to claim 21, comprising an in situ steam generator placed inside the feed-through or placed externally from the feed-through and connected to the inside of the feed-through via a connecting tube.

26. Apparatus according to claim 21, comprising a funnel placed under the microwave oven in order to collect crude isolates.

27. Apparatus according to claim 21, wherein the apparatus is at atmospheric pressure.

28. Apparatus according to claim 21, wherein the natural products are essential oils.

29. Method according to claim 1, comprising carrying out said method under reduced pressure.

30. Method according to claim 1, comprising carrying out said method under greater than atmospheric pressure.

31. Method according to claim 1, wherein the temperature of isolation is between 50° C. and 100° C.

32. Method according to claim 1, wherein the biological material contains moisture.

33. Apparatus according to claim 18, wherein the steam generator generates steam from cotton or water.

34. Apparatus according to claim 19, wherein the steam generator generates steam from cotton or water.

35. Apparatus according to claim 21, wherein the apparatus is under vacuum.

36. Apparatus according to claim 21, wherein the apparatus is under greater than atmospheric pressure.
